(19) United States
(12) Patent Application Publication
(10) Pub. No.: US 2019/0143945 A1
(43) Pub. Date: May 16, 2019

(54) CONTROLLING POWER TO A HEATED SURFACE

(71) Applicant: Rosemount Aerospace Inc., Burnsville, MN (US)

(72) Inventors: Matthew Webb, Lakeville, MN (US); Peter Mann-Lai Chong, Lakeville, MN (US)

(21) Appl. No.: 15/813,458

(22) Filed: Nov. 15, 2017

(51) Int. Cl. B60S 1/02; H05B 1/02; B64D 15/20; H05B 3/84

(52) U.S. Cl. CPC B60S 1/026; H05B 1/023; H05B 2203/035; H05B 3/84; B64D 15/20

(57) ABSTRACT

A surface heating system of an external surface of a vehicle system includes a heater and a heater controller. The heater is configured to provide heat to the external surface. The heater controller is configured to control a heater power of the heater based upon an air temperature of air external to the vehicle, a liquid water content of the air, and a speed of the vehicle.

### BACKGROUND

A typical windscreen installed on an aircraft uses an embedded heater to keep the windscreen free of ice and fog. Aircraft windscreens use an embedded temperature sensor to monitor the temperature of the windscreen and provide feedback to a heater controller as part of a closed loop system. When the temperature sensor(s) of an aircraft windscreen is damaged or otherwise compromised, the whole windscreen typically must be replaced to maintain an adequately functioning windscreen heating system.

### SUMMARY

In one example, a surface heating system of an external surface of a vehicle system comprises a heater and a heater controller. The heater is configured to provide heat to the external surface. The heater controller is configured to control a heater power of the heater based upon an air temperature of air external to the vehicle, a liquid water content of the air, and a speed of the vehicle.

In one example, a method comprises receiving data, using one or more communication devices, corresponding to an external air temperature of a vehicle, a liquid water content of air, and a speed of the vehicle; determining, in response to receiving the data, a power to maintain a temperature of a surface of the vehicle based upon the received data using one or more processors; adjusting, in response to determining the power, a heater power based upon the determined power using a power supply.

### BRIEF DESCRIPTION OF THE DRAWINGS

FIG. 1 is a block diagram of an exterior surface heater control system.

FIG. 2 is a graph depicting the power per square inch needed to maintain a temperature of an exterior surface using an exterior surface heater control system as a function of the mass flow of the exterior surface.

FIG. 3 is a flow diagram depicting a process for maintaining the temperature of an exterior surface using a heater controller of an exterior surface heater control system.

### DETAILED DESCRIPTION

Apparatus, systems, and associated methods relate to heating an exterior surface of a vehicle. Using the apparatus, systems, and associated methods herein, allows for the control of an exterior surface heater without an embedded temperature sensor. The heater is controlled based upon parameters including one or more of an external air temperature, a liquid water content of the external air, and a speed of the vehicle. In this way, there is no embedded temperature sensor to get damaged or fail and require the exterior surface to need replacing.

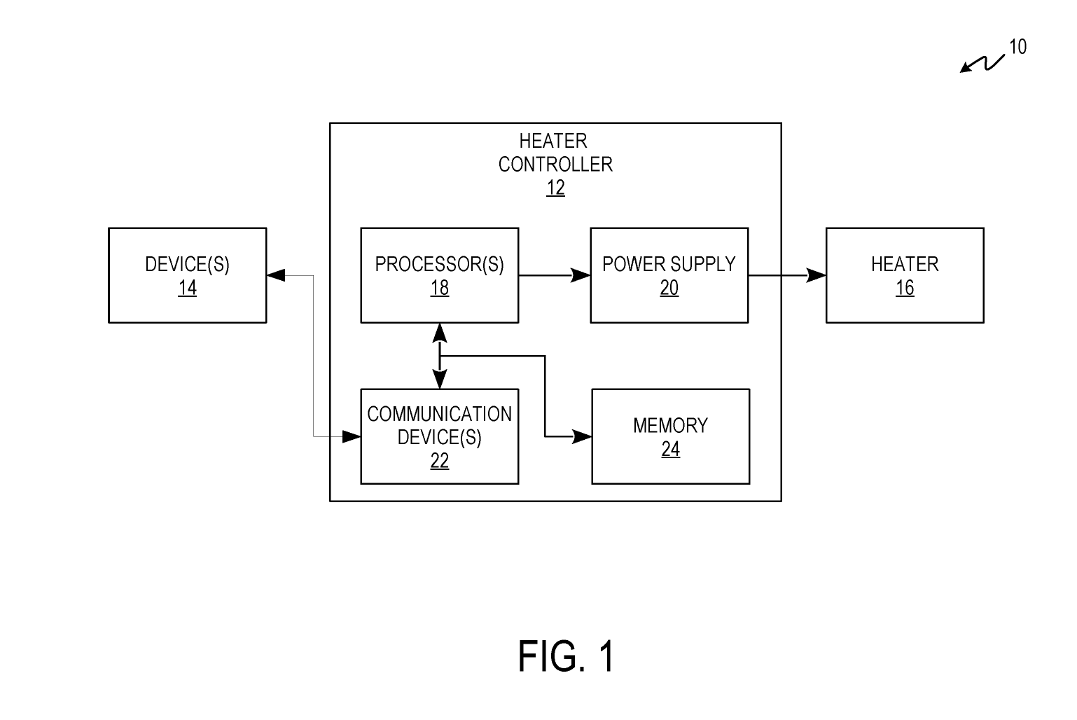

FIG. 1 is a block diagram of exterior surface heater control system 10 including heater controller 12, device(s) 14, and heater 16. Heater controller 12 includes processor(s) 18, power supply 20, communication device(s) 22, and memory 24.

Device(s) 14 is configured to aggregate and transmit sensed parameters to heater controller 12. Device(s) 14 can include aircraft condition monitoring systems, a sensor network, a vehicle monitoring and control unit, or other computing system. Device(s) 14 can communicate using a network interface card, such as an Ethernet card, an optical transceiver, a radio frequency transceiver, or any other type of device that can send and receive information. Other examples of such network interfaces can include Bluetooth, 3G, 4G, and WiFi radio computing devices, as well as Universal Serial Bus (USB).

Heater 16 is configured to heat an exterior surface of a vehicle. Heater 16 can be embedded in the surface or in contact with the surface. Heater 16 is configured to receive heater power from heater controller 12. Heater controller 12 is configured to control the heater power of heater 16 based upon sensed parameters. The sensed parameters can include, for example, an air temperature, a liquid water content of the air, and a speed of the vehicle. Heater controller 12 is configured to adjust the heater power inversely with the air temperature. As the air temperature increases, heater controller 12 is configured to decrease the heater power. As the air temperature decreases, heater controller 12 is configured to increase the heater power. Heater controller 12 is configured to adjust the heater power proportionally to the liquid water content. As the liquid water content increases, heater controller 12 is configured to increase the heater power. As the liquid water content decreases, heater controller 12 is configured to decrease the heater power. Heater controller 12 is configured to adjust the heater power proportionally with the speed of the vehicle. In one example, the vehicle is an aircraft and heater controller 12 is further configured to control the heater power based upon an altitude of the aircraft. Heater controller 12 is configured to adjust the heater power proportionally with the altitude of the aircraft. In a further example the exterior surface is a windscreen of the aircraft.

Heater controller 12 includes communication device(s) 22 to communicate with external device(s) 14 via one or more wired or wireless networks, or both. Communication device(s) 22 can include a network interface card, such as an Ethernet card, an optical transceiver, a radio frequency transceiver, or any other type of device that can send and receive information. Other examples of such network interfaces can include Bluetooth, 3G, 4G, and WiFi radio computing devices, as well as Universal Serial Bus (USB). In one example, communication device(s) 22 are configured to receive data corresponding to sensed parameters of vehicle sensors from device(s) 14. Data received by communication device(s) 22 includes the air temperature, the liquid water content of the air, the speed of the vehicle, and the altitude of the vehicle.

Processor(s) 18, in one example, are configured to implement functionality and/or process instructions for execution within heater controller 12. For instance, processor(s) 18 can be capable of processing instructions stored in memory of processor(s) 18. Examples of processor(s) 18 can include any one or more of a microprocessor, a controller, a digital signal processor (DSP), an application specific integrated circuit (ASIC), a field-programmable gate array (FPGA), or other equivalent discrete or integrated logic circuitry. In one example, processor(s) 18 are configured to receive data corresponding to the sensed one or more parameters and translate the data for transmission by communication device(s) 22. In one example, processor(s) 18 are configured to determine a power to maintain a temperature of an exterior surface based upon parameters such as the air temperature, the liquid water content of the air, and the speed of the vehicle. Processors(s) 18 are further configured to control power supply 20 to adjust the heater power supplied to heater 16 based upon the determined power.

Computer-readable memory 24 can be configured to store information within heater controller 12 during operation. Computer-readable memory 24, in some examples, is described as a computer-readable storage medium. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, computer-readable memory 24 is a temporary memory, meaning that a primary purpose of computer-readable memory 24 is not long-term storage. Computer-readable memory 24, in some examples, is described as a volatile memory, meaning that computer-readable memory 24 does not maintain stored contents when power to heater controller 12 is removed. Examples of volatile memories can include random access memories (RAM), dynamic random access memories (DRAM), static random access memories (SRAM), and other forms of volatile memories. In some examples, computer-readable memory 24 is used to store program instructions for execution by processor(s) 18. Computer-readable memory 24, in certain examples, is used by processing applications running on heater controller 12 to temporarily store information during program execution, such as controlling the heater power supplied to heater 16, determining the power needed to maintain a temperature of the exterior surface, and/or transmitting and receiving data using communication device(s) 22.

Computer-readable memory 24, in some examples, also includes one or more computer-readable storage media. Computer-readable memory 24 can be configured to store larger amounts of information than volatile memory. Computer-readable memory 24 can further be configured for long-term storage of information. In some examples, computer-readable memory 24 include non-volatile storage elements. Examples of non-volatile storage elements can include magnetic hard discs, optical discs, floppy discs, flash memories, or forms of electrically programmable memories (EPROM) or electrically erasable and programmable (EEPROM) memories. In one example, computer-readable memory 24 is configured to store data including a look up table of parameters or surface area of the exterior surface.

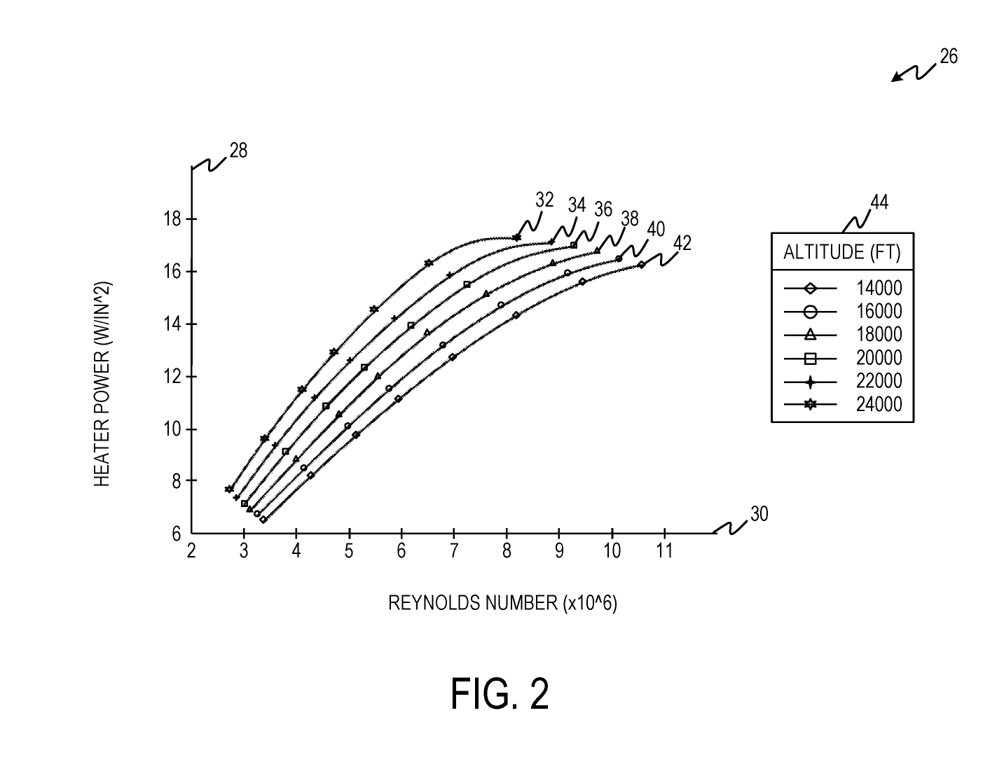

FIG. 2 is graph 26 depicting the power per square inch needed to maintain a temperature of an exterior surface using an exterior surface heater control system as a function of the mass flow of the exterior surface. Graph 26 includes y-axis 28; x-axis 30; curves 32, 34, 36, 38, 40, and 42; and legend 44.

Y-axis 28 represents the power needed to maintain a temperature of an exterior surface in watts per square inch. X-axis 30 represents the Reynolds number, which is dimensionless, at the exterior surface. Alternatively, mass flow or any other parameter that correlates with forced convection could be used. Curves 32, 34, 36, 38, 40, and 42 depict the power to maintain the temperature as a function of mass flow at altitudes of 14,000; 16,000; 18,000; 20,000; 22,000; and 24,000 feet respectively as shown in legend 44. FIG. 2 is for a constant static temperature. In the simplest form, FIG. 2 may be generalized to all conditions, including the presence of cloud, with the equation:

Q=hA(T_{w}−Tᵣ)+LWC−VβA(T_{w}−Tₛ)+LᵥA\dot{m}ₑᵥₐₚ (Equation 1)

Q is the power needed to maintain the wall temperature, T_{w}. The convection coefficient, h, is primarily a function of the Reynolds number, or the mass flow. That is, h increases with increasing mass flow. It is relatively straight-forward to determine the value of h from computational fluid dynamics analysis or based on wind tunnel data. Therefore, based on air data parameters, it is possible to provide a good estimate of the heater power required for a given surface area, A, to maintain the desired T_{w} in dry air. The last two terms in the equation account for liquid in the air, such as in a cloud or fog. The aircraft velocity, V and the static temperature, Tₛ, can be determined from aircraft air data, while the collection efficiency can be determined from computational fluid dynamics analysis. The addition of a droplet size measurement may improve the estimate of required heater power if collection efficiency changes significantly with droplet size. Additionally, a measurement of Liquid Water Content (LWC) is used to estimate the required heater power to maintain a given wall temperature in cloud. In the last term, mₑᵥₐₚ is the evaporated mass flux of water and is primarily a function of T_{w}, Tₛ and the aircraft altitude. The latent heat of vaporization, Lᵥ, can be considered to be constant or known. It is possible to add additional terms to Equation 1 to account for other physics. An example would be including the heat transfer from water run-back if the entire wall is not maintained at a uniform temperature or including transient thermal effects.

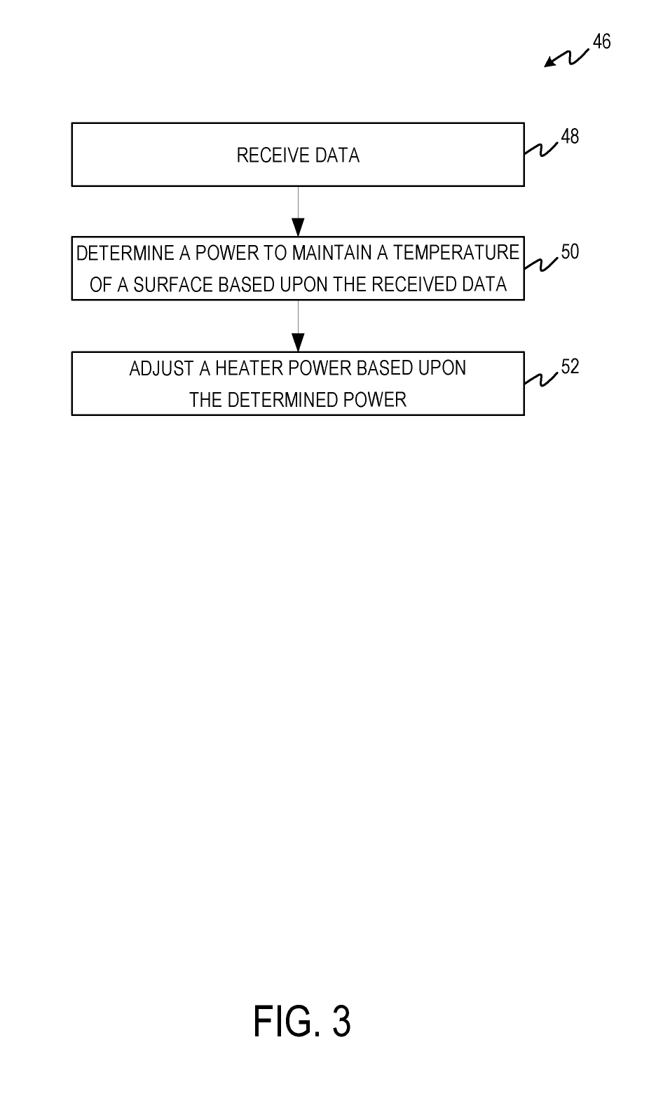

FIG. 3 is a flow diagram depicting process 46 for maintaining a temperature of an exterior surface of a vehicle. For purposes of clarity and ease of discussion, the example operations are described below within the context of exterior surface heater control system 10 of FIG. 1.

At step 48, data corresponding to an external air temperature of the vehicle, liquid water content of the air, and a speed of the vehicle is received using one or more communication device(s) 22. The data received from one or more device(s) 14 includes an exterior air temperature, a liquid water content of the air, and a speed of the vehicle. In one example, the data further includes an altitude of the vehicle. At step 50, a power to maintain the temperature of the exterior surface is determined, in response to receiving the data, using one or more processors 18 based upon the received data. Determining the power includes the power being inversely related to the air temperature, positively related to the liquid water content, and positively related to the speed of the vehicle. In one example, determining the power includes the power being positively related to the altitude of the vehicle. In a further example, the determining the power includes the power being positively related to a surface area of the exterior surface. At step 52, a heater power is adjusted, in response to determining the power, based upon the determined power using power supply 20.

Accordingly, implementing techniques of this disclosure, an exterior surface heater can be controlled without a temperature sensor. Using the exterior surface heating system described herein, a surface can be heated in a controlled manner without embedded temperature sensors which add a point of failure for the surface. This lowers the likelihood of the surface failing and needing to be replaced.

### Discussion of Possible Embodiments

The following are non-exclusive descriptions of possible embodiments of the present invention.

A surface heating system of an external surface of a vehicle, the system can comprise a heater configured to provide heat to the external surface; a heater controller configured to control a heater power of the heater based upon an air temperature of air external to the vehicle, a liquid water content of the air, and a speed of the vehicle.

The surface heating system of the preceding paragraph can optionally include, additionally and/or alternatively, any one or more of the following features, configurations and/or additional components:

The heater controller can be configured to increase the heater power in response to the air temperature decreasing; and the heater controller can be configured to decrease the heater power in response to the air temperature increasing.

The heater controller can be configured to increase the heater power in response to the liquid water content of the air increasing; and the heater controller can be configured to decrease the heater power in response to the liquid water content of the air decreasing.

The heater controller can be configured to increase the heater power in response to the speed of the vehicle increasing; and the heater controller can be configured to decrease the heater power in response to the speed of the vehicle decreasing.

The heater controller can be further configured to control the heater power based upon an altitude of the aircraft.

The surface of the vehicle can be a windscreen of the aircraft.

The heater controller can be configured to increase the heater power in response to the altitude of the aircraft increasing; and the heater controller can be configured to decrease the heater power in response to the altitude of the aircraft decreasing.

The heater controller can be further configured to receive the air temperature, the liquid water content, and the speed of the vehicle from a condition monitoring system of the aircraft.

The heater controller can be further configured to control the heater power based upon a surface area of the external surface.

A method comprising: receiving data, using one or more communication devices, corresponding to an external air temperature of a vehicle, a liquid water content of air, and a speed of the vehicle; determining, in response to receiving the data, a power to maintain a temperature of a surface of the vehicle based upon the received data using one or more processors; adjusting, in response to determining the power, a heater power based upon the determined power using a power supply.

Determining the power includes the power being inversely related to the external air temperature.

Determining the power includes the power being positively related to the liquid water content of the air.

The determining the power includes the power being positively related to the speed of the vehicle.

The vehicle can be an aircraft.

Receiving data further includes receiving data corresponding to an altitude of the aircraft.

The surface of the vehicle can be a windscreen of the aircraft.

Determining the power can be further based upon the altitude of the aircraft.

Determining the power includes the power being positively related to the altitude of the vehicle.

Determining the power can be further based upon a surface area of the external surface.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A surface heating system of an external surface of a vehicle, the system comprising:
a heater configured to provide heat to the external surface;
a heater controller configured to control a heater power of the heater based upon an air temperature of air external to the vehicle, a liquid water content of the air, and a speed of the vehicle.

2. The surface heating system of claim 1, wherein:
the heater controller is configured to increase the heater power in response to the air temperature decreasing; and
the heater controller is configured to decrease the heater power in response to the air temperature increasing.

3. The surface heating system of claim 1, wherein:
the heater controller is configured to increase the heater power in response to the liquid water content of the air increasing; and
the heater controller is configured to decrease the heater power in response to the liquid water content of the air decreasing.

4. The surface heating system of claim 1, wherein:
the heater controller is configured to increase the heater power in response to the speed of the vehicle increasing; and
the heater controller is configured to decrease the heater power in response to the speed of the vehicle decreasing.

5. The surface heating system of claim 1, wherein the vehicle is an aircraft.

6. The surface heating system of claim 5, wherein the heater controller is further configured to control the heater power based upon an altitude of the aircraft.

7. The surface heating system of claim 6, wherein the surface of the vehicle is a windscreen of the aircraft.

8. The surface heating system of claim 5, wherein:
the heater controller is configured to increase the heater power in response to the altitude of the aircraft increasing; and
the heater controller is configured to decrease the heater power in response to the altitude of the aircraft decreasing.

9. The surface heating system of claim 5, wherein the heater controller is further configured to receive the air temperature, the liquid water content, and the speed of the vehicle from a condition monitoring system of the aircraft.

10. The surface heating system of claim 1, wherein the heater controller is further configured to control the heater power based upon a surface area of the external surface.

11. A method comprising:
receiving data, using one or more communication devices, corresponding to an external air temperature of a vehicle, a liquid water content of air, and a speed of the vehicle;
determining, in response to receiving the data, a power to maintain a temperature of a surface of the vehicle based upon the received data using one or more processors;
adjusting, in response to determining the power, a heater power based upon the determined power using a power supply.

12. The method of claim 11, wherein determining the power includes the power being inversely related to the external air temperature.

13. The method of claim 11, wherein determining the power includes the power being positively related to the liquid water content of the air.

14. The method of claim 11, wherein determining the power includes the power being positively related to the speed of the vehicle.

15. The method of claim 11, wherein the vehicle is an aircraft.

16. The method of claim 15, wherein receiving data further includes receiving data corresponding to an altitude of the aircraft.

17. The method of claim 16, wherein the surface of the vehicle is a windscreen of the aircraft.

18. The method of claim 15, wherein determining the power is further based upon the altitude of the aircraft.

19. The method of claim 15, wherein determining the power includes the power being positively related to the altitude of the vehicle.

20. The method of claim 11, wherein determining the power is further based upon a surface area of the external surface.
